(19) United States
(12) Patent Application Publication
(10) Pub. No.: US 2026/0057012 A1
(43) Pub. Date: Feb. 26, 2026

(54) INFORMATION PROCESSING DEVICE, INFORMATION PROCESSING METHOD, AND COMPUTER PROGRAM PRODUCT

(71) Applicant: KABUSHIKI KAISHA TOSHIBA, Tokyo (JP)

(72) Inventors: Shigeru MAYA, Edogawa (JP); Ken UENO, Tachikawa (JP)

(73) Assignee: KABUSHIKI KAISHA TOSHIBA, Tokyo (JP)

(21) Appl. No.: 19/256,805

(22) Filed: Jul. 1, 2025

(30) Foreign Application Priority Data
Aug. 26, 2024 (JP) 2024-143973

(51) Int. Cl. G06F 16/903; G06F 16/901

(52) U.S. Cl. CPC G06F 16/90344; G06F 16/9024

(57) ABSTRACT

An information processing device configured to: extract, for each of a plurality of pieces of first input information including a target string representing a target and a category string representing a category to which the target belongs, a first substring included in the target string, and extract, from the first substring, a second substring using the category string; determine a second substring associated with the target string included in the first input information; and train first feature information and second feature information to increase a matching rate between a category of the target string estimated from the second feature information and a category represented by the category string, the first feature information representing a feature of the determined second substring, the second feature information representing a feature of the target string including the determined second substrings, and being calculated based on the first feature information.

### CROSS-REFERENCE TO RELATED APPLICATIONS

This application is based upon and claims the benefit of priority from Japanese Patent Application No. 2024-143973, filed on Aug. 26, 2024; the entire contents of which are incorporated herein by reference.

### FIELD

Embodiments described herein relate generally to an information processing device, an information processing method, and a computer program product.

### BACKGROUND

With the advancement of the Internet of Things (IoT), the utilization of purchasing data, which indicates a purchaser and the purchased product, is accelerating. In particular, information representing a product category is expected to be used for new product development, marketing, customer profiling, promotions, and the like. In the past, experts often selected a corresponding category from a huge set of categories based on a product name, which resulted in an enormous burden in the case of a large number of products. To address this challenge, the use of machine learning and data mining is progressing. For example, a technique has been employed that extracts a feature value from a product name and estimates a category based on the extracted feature value.

### BRIEF DESCRIPTION OF THE DRAWINGS

FIG. 1 is a block diagram of an information processing device according to a first embodiment;

FIG. 2 is a diagram illustrating an example of the data structure of a product master;

FIG. 3 is a flowchart of substring extraction processing in an embodiment;

FIG. 4 is a diagram illustrating a specific example of the substring extraction processing;

FIG. 5 is a flowchart of graph generation processing in the first embodiment;

FIG. 6 is a diagram illustrating a specific example of the graph generation processing;

FIG. 7 is a flowchart of learning processing;

FIG. 8 is a flowchart of estimation processing;

FIG. 9 is a block diagram of an information processing device according to a second embodiment;

FIG. 10 is a flowchart of graph generation processing in the second embodiment;

FIG. 11 is a block diagram of an information processing device according to a third embodiment;

FIG. 12 is a diagram illustrating an example of a category estimation method by a learning unit and an estimation unit;

FIG. 13 is a flowchart of learning processing in the third embodiment;

FIG. 14 is a block diagram of an information processing device according to a fourth embodiment;

FIG. 15 is a flowchart of information processing in the fourth embodiment;

FIG. 16 is a diagram illustrating an example of the calculation of an embedding representation according to an embodiment;

FIG. 17 is a block diagram of an information processing device according to a fifth embodiment;

FIG. 18 is a flowchart of estimation processing in the fifth embodiment; and FIG. 19 is a hardware configuration diagram of information processing devices according to the first to fifth embodiments.

### DETAILED DESCRIPTION

According to an embodiment, an information processing device includes one or more hardware processors configured to: extract, for each of a plurality of pieces of first input information including a target string representing a target and a category string representing a category to which the target belongs, one or more first substrings included in the target string, and extract, from the one or more first substrings included in the target string, one or more second substrings using the category string; determine, for each of the plurality of pieces of first input information, one or more second substrings associated with the target string included in the first input information; and execute learning processing to train first feature information and second feature information to increase a matching rate between a category of the target string estimated from the second feature information and a category represented by the category string, the first feature information representing a feature of the determined one or more second substrings, the second feature information representing a feature of the target string including the determined one or more second substrings, the second feature information being calculated based on the first feature information.

Exemplary preferred embodiments of an information processing device according to the present disclosure are described below in detail with reference to the accompanying drawings.

Hereinafter, a case will be described as an example where the target of a category to be estimated is a product, and a target string, which is a string representing the target (i.e., the product), is a product name. The target and the target string are not construed to be limited to products and product names, respectively.

To estimate a category to which a product belongs, for example, a technique has been employed in which a string representing a product name is divided into substrings and the category is estimated using the substrings. In many cases, a product name has a small number of characters, and the accuracy of category estimation is highly likely to vary significantly depending on the approach to selecting a substring. For example, substrings are not necessarily specialized for the product category estimation and can sometimes fail to contribute to improving the accuracy of category estimation.

A technique has also been employed in which feature values of strings are obtained using large language models (LLM) to estimate a category of a product. However, since such large language models are trained based on information sources such as web pages, they are not directly related to category estimation tasks, potentially leading to a decrease in the accuracy of category estimation.

### First Embodiment

An information processing device according to a first embodiment uses information regarding a product for which a category-representing string (category string) is available in advance to extract a substring of a product name and to learn a feature value of the extracted substring. Then, the information processing device according to the present embodiment uses the trained feature value to estimate a category of a product specified as an estimation target.

This makes it possible to estimate the category of a product with higher accuracy. The product for which a category string is available in advance can be only a portion of a large number of products. Thus, the selection of a category by an expert or the like for a large number of products can be avoided, thereby reducing the burden associated with category selection.

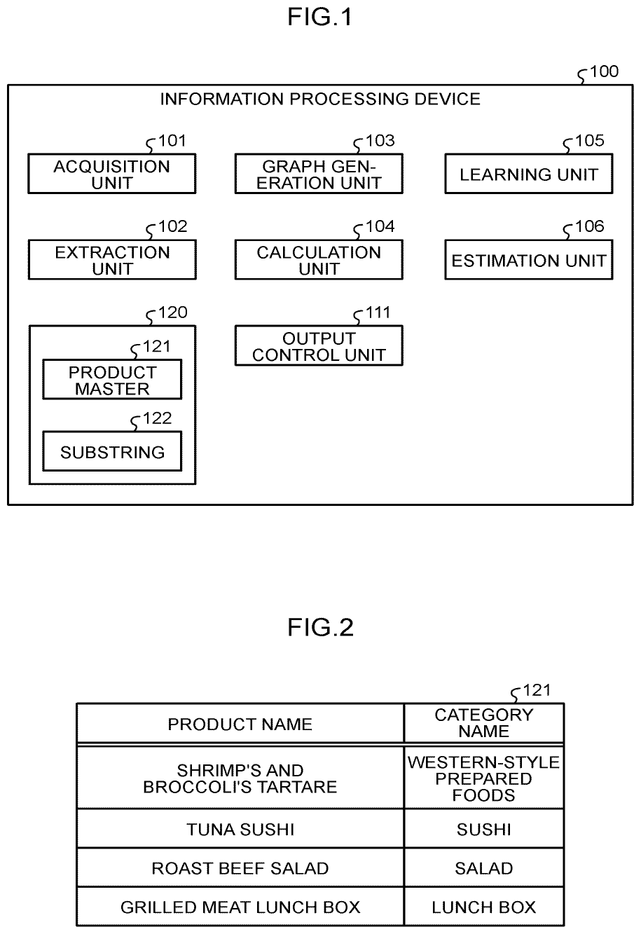

FIG. 1 is a block diagram illustrating an example of the configuration of an information processing device 100 of the first embodiment. As illustrated in FIG. 1, the information processing device 100 includes a storage unit 120, an acquisition unit 101, an extraction unit 102, a graph generation unit 103, a calculation unit 104, a learning unit 105, an estimation unit 106, and an output control unit 111.

The storage unit 120 stores various types of information used in the information processing device 100. The storage unit 120 stores, for example, a product master 121 and a substring 122. The substring 122 is a substring extracted from a product name by the extraction unit 102.

The product master 121 corresponds to product-related information obtained in advance. FIG. 2 is a diagram illustrating an example of the data structure of the product master 121. As illustrated in FIG. 2, the product master 121 includes a product name and a category name. The product name corresponds to a string (target string) representing the name of a product. The category name corresponds to a category string representing the category of a product. The product master 121 corresponds to a plurality of input information ID1 (first input information) including a target string representing a target and a category string representing a category to which the target belongs.

At least a portion of the information included in the product master 121 can be subjected to predetermined preprocessing. For example, the product name can be subjected to preprocessing such as processing to unify to full-width characters, processing to unify to uppercase characters, and other normalization processing. In some cases, only a portion of the product name can be displayed to reduce the capacity of the database. Thus, in this case, the processing of restoring the omitted string by interpolating the product name can be executed as preprocessing. The result of the interpolation is registered as the product name in the product master 121.

Each product name can be assigned one category (category name) or multiple categories. The product master 121 can be subjected to preprocessing related to a category. For example, a category whose number of occurrences within the product master 121 does not reach a specified number can be deleted from the product master 121 to be excluded from an estimation target. Additionally, in the case where multiple categories are treated as the same single category, information indicating their relationship can be registered.

Moreover, the storage unit 120 can be configured with any commonly used storage medium, such as flash memory, a memory card, random-access memory (RAM), a hard disk drive (HDD), or an optical disk. A portion or the entirety of the data (product master 121 or substring 122) stored in the storage unit 120 can be stored in physically different storage media or in different storage areas of the same physically stored medium.

Reference is made again to FIG. 1. The acquisition unit 101 acquires various types of information used by the information processing device 100. For example, the acquisition unit 101 acquires the product master 121, a threshold used in the processing of each component (such as a threshold for the number of products or a threshold for the ratio), an extraction condition for a substring, and the number of dimensions of a feature value (such as embedding representation). The extraction condition for a substring is, for example, the number of characters of the substring to be extracted (such as two to six characters).

The approach by which the acquisition unit 101 acquires information can employ any method, such as, for example, receiving information from an external device via a network or reading information from a storage medium.

The acquisition unit 101 can perform predetermined preprocessing on the acquired information. For example, the acquisition unit 101 can execute preprocessing on the product master 121 as described above.

The extraction unit 102 extracts one or more substrings from the input information ID1 for each of a plurality of pieces of input information ID1 included in the product master 121. The extraction unit 102 is configured to extract a substring useful for estimating a category.

For example, the extraction unit 102 extracts one or more substrings PT1 (first substring) included in the product name (target string) for each of the plurality of pieces of input information ID1. Then, the extraction unit 102 extracts one or more substrings PT2 (second substring) from one or more substrings PT1 included in the product name using a category name (category string).

For example, for each of one or more substrings PT1, the extraction unit 102 extracts, as the substring PT2, the substring PT1 if its associated determination value is higher than those of other substrings PT1, among one or more category names (category strings) corresponding to product names including the substring PT1. The determination value is, for example, at least one of the number n of corresponding product names and the ratio of the number n to the total number of product names including the substring PT1 (correct matching rate).

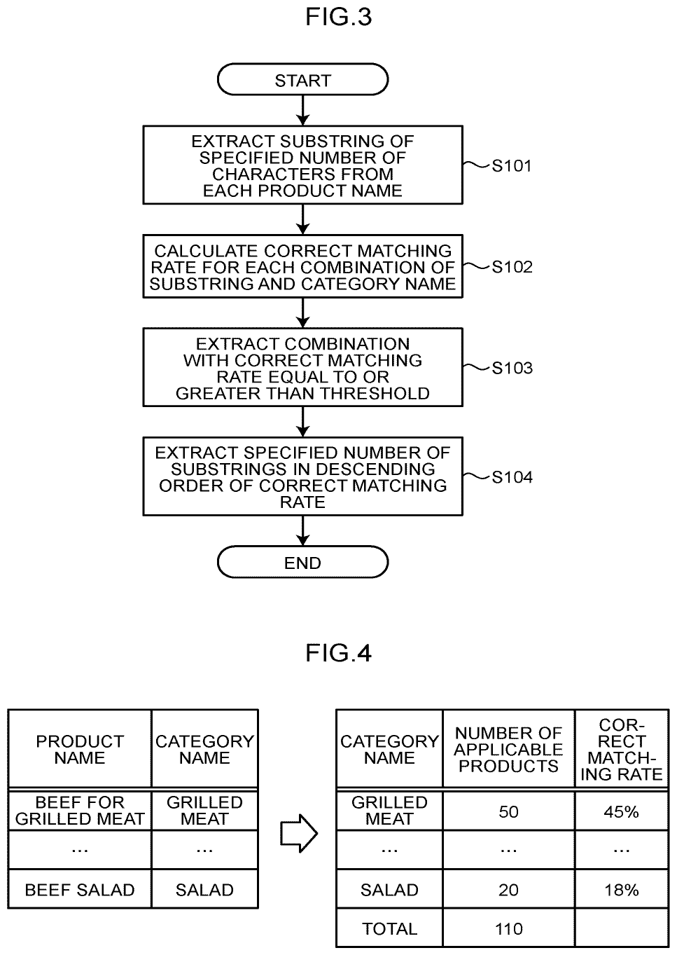

FIG. 3 is a flowchart illustrating an example of substring extraction processing in the present embodiment.

The extraction unit 102 extracts one or more substrings PT1 that are substrings of a specified number of characters (e.g., two to six characters) from each product name included in the product master 121 (step S101).

The extraction unit 102 calculates a correct matching rate for each combination of the substring PT1 and the corresponding category name (step S102). As described above, the correct matching rate is the ratio of the number n of product names corresponding to the category name to the total number of product names including the substring PT1.

The extraction unit 102 extracts one or more combinations for which the correct matching rate is equal to or greater than a threshold THA (step S103). The extraction unit 102 extracts a specified number of substrings PT1 in descending order of the correct matching rate from the substrings PT1 included in the one or more extracted combinations as one or more substrings PT2 (step S104) and then completes the substring extraction processing.

Moreover, any method can be used to extract the substring PT1 in step S101, and for example, the following extraction method can be used:
(EM1) A method of enumerating all substrings of a specified number of characters,
(EM2) A method of utilizing substrings segmented by a word segmentation method such as MeCab,
(EM3) A method of dividing a product name into one or more substrings PT1 using a predetermined character (such as a space) in accordance with the language (such as Japanese or English) being employed, and
(EM4) A method of extracting one or more substrings from a category name as the substrings PT1 in addition to extracting substrings from a product name.

The item (EM4) described above is a method that considers that information useful for estimating a category for a product name can also be included in the category name. Two or more of the methods mentioned above can be used. In this case, the extraction unit 102 can adjust the threshold THA used for extracting the substring PT2 from the substring PT1 extracted by each of the multiple methods such that the values are mutually different for the multiple methods. This makes it possible to more appropriately extract the substring PT2 that is useful for category estimation.

FIG. 4 illustrates a specific example of the substring extraction processing. FIG. 4 illustrates an example in which attention is focused on “beef” as the substring PT1. As illustrated in FIG. 4, a product including “beef” is expected to be included in numerous categories, such as the “grilled meat” category and the “salad” category. The extraction unit 102 assesses that the correct matching rate of 45% for the “grilled meat” category, which has the largest number of corresponding products, is greater than, for example, the threshold THA of 40%, and then extracts “beef”as the substring PT2.

The extraction unit 102 also performs such processing on other substrings PT1 (e.g., “grilled meat” and “salad”) to extract one or more substrings PT2. As illustrated in the flowchart of FIG. 3, the extraction unit 102 can further extract a specified number of substrings PT2 from the extracted substring PT2 in descending order of the correct matching rate.

The extraction unit 102 extracts the substring PT2 for each product name included in the product master 121 through the above-described processing and stores the extracted substring PT2 in the storage unit 120 as the substring 122. The stored substring PT2 (substring 122) is referenced, for example, in graph generation processing by the graph generation unit 103 and feature value (embedding representation) calculation processing by the calculation unit 104.

Reference is made again to FIG. 1. The graph generation unit 103 generates a graph including the product name and one or more substrings PT2 included in the product name. For example, for each of the plurality of pieces of input information ID1 included in the product master 121, the graph generation unit 103 determines one or more substrings PT2 that are associated with the product name included in the input information ID1. The graph generation unit 103 generates a graph including the determined substring PT2 and the product name.

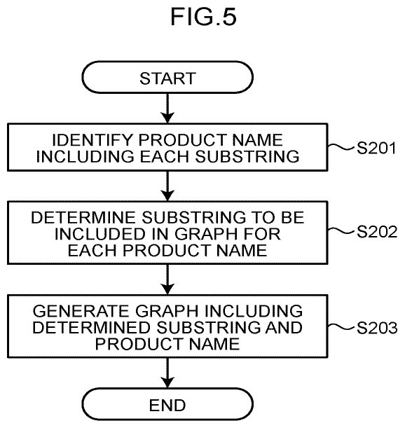

FIG. 5 is a flowchart illustrating an example of the graph generation processing in the first embodiment.

The graph generation unit 103 identifies a product name including the substring PT2 for each of the extracted one or more substrings PT2 (step S201). As a result, for each product name, the substring PT2 included in the product name is identified. The graph generation unit 103 can also identify, for each of one or more product names included in the product master 121, the substring PT2 included in the product names from the substring 122 stored in the storage unit 120.

The graph generation unit 103 determines, for each product name, the substring PT2 included in the product name to be included in the graph from among the substrings PT2 included in the product name (step S202). The graph generation unit 103 generates a graph including the determined substring and the product name (step S203) and then completes the graph generation processing.

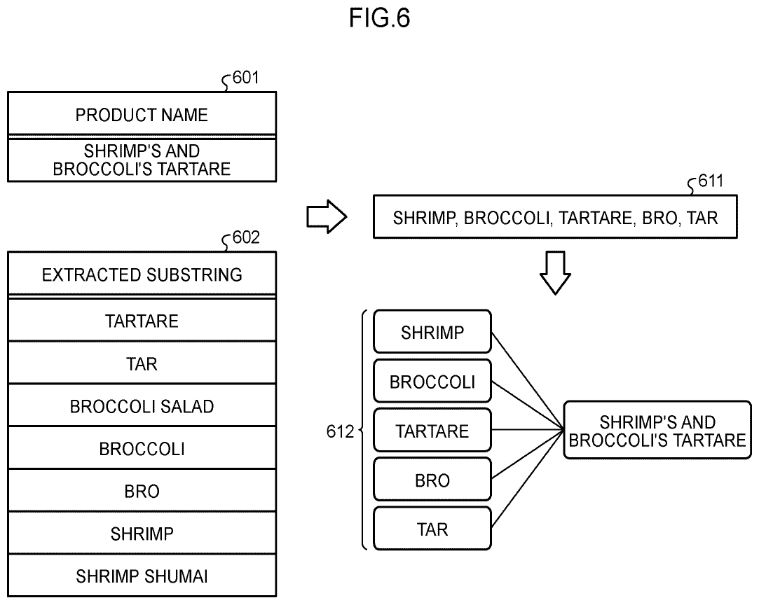

FIG. 6 is a diagram illustrating a specific example of the graph generation processing. FIG. 6 illustrates an example of the graph generation processing for a product name 601, which is “shrimp's and broccoli's tartare”. It is assumed that at least seven substrings included in a substring group 602 are extracted as the substrings PT2.

For example, for each of the seven substrings, in the case where the product name 601 is identified as the product name including the relevant substring, the graph generation unit 103 determines the relevant substring as the substring to be included in the graph for the product name 601. A substring group 611 indicates an example of five substrings determined in this manner. The graph generation unit 103 generates a graph 612 including edges connecting each of the substrings to the product name, with the determined substrings and the product name as nodes.

The method of determining the substrings to be included in the graph is not limited to the example described above. For example, the graph generation unit 103 can determine the substrings to be included in the graph using the following methods:
(DM1) A method of determining a substring to be included in the graph in the case where a portion of the substring is included in the product name, and
(DM2) A method of converting the character types (such as, kanji, hiragana, and katakana-Japanese characters) into a unified form and assessing whether or not strings match. For example, for strings including kanji, hiragana, and katakana characters, the kanji and katakana are converted into hiragana, and it is assessed whether or not they match.

Reference is made again to FIG. 1. The calculation unit 104 calculates feature information (feature value) of the product name. The feature value can be in any format, but for example, it is an embedding representation in which the product name is represented by a vector with a specified number of dimensions.

The calculation unit 104 uses an embedding representation F1 (first feature information) of the substring included in the graph generated by the graph generation unit 103 to calculate an embedding representation F2 (second feature information) of the product name included in the graph. For example, the calculation unit 104 calculates the embedding representation F2 of the product name included in the graph by adding the embedding representation F1 of one or more substrings included in the graph.

The calculation unit 104 can calculate the embedding representation of the product name by utilizing a graph analysis technique such as graph neural network (GNN). For example, the calculation unit 104 can calculate an average value of the embedding representation F1 of the substrings included in the graph as the embedding representation F2 of the product name included in the graph.

Moreover, the method of calculating the embedding representation F2 is not limited to the method using a graph, and any other method can be employed as long as the embedding representation F2 can be calculated from the embedding representation F1 of the substring. In the case where a graph is not used, the graph generation unit 103 can be omitted.

At the start of learning, the embedding representation F1 of the substring can be set to an initial value. The initial value is, for example, a value selected at random. During estimation using the trained feature information (embedding representation), the trained embedding representation F1 is used to calculate the embedding representation F2 of the product name.

The learning unit 105 executes learning processing of training the embedding representation F1 of the substring and the embedding representation F2 of the product name. For example, the learning unit 105 executes the learning processing so that the matching rate between the category estimated from the embedding representation F2 and the category represented by the category name (category string) corresponding to the product name in the product master 121 increases. The category represented by the category name corresponding to the product name in the product master 121 corresponds to the correct category.

The method of estimating the category from the embedding representation F2 can be any method, but for example, a method using a pre-trained estimation model EMA can be applied. The estimation model EMA is, for example, a model that is trained to receive an embedding representation as input and output the probability of each of a plurality of categories. The probability of a category corresponds to a value indicating the likelihood that a product corresponding to an embedding representation belongs to the relevant category. The category with the highest probability corresponds to the estimation result (estimated value) of the category. The estimation model EMA can be a model that outputs the single most probable category among the plurality of categories.

Data indicating the probability of each of a plurality of categories can be understood as a vector including elements whose element values are probabilities, corresponding to the number of the plurality of categories. In other words, the estimation model EMA can be understood as a model that outputs an embedding representation different from the embedding representation F2, with the number of categories being the number of dimensions.

In the learning processing, the learning unit 105 updates the value of the embedding representation F1 of the substring that is the calculation source of the embedding representation F2, for example, in accordance with the error backpropagation method or the like, so that the matching rate between the category estimated from the embedding representation F2 and the category represented by the category name (category string) corresponding to the product name in the product master 121 increases. Updating the value of the embedding representation F1 of the substring can be understood as equivalent to updating the value of the embedding representation F2 calculated using the embedding representation F1.

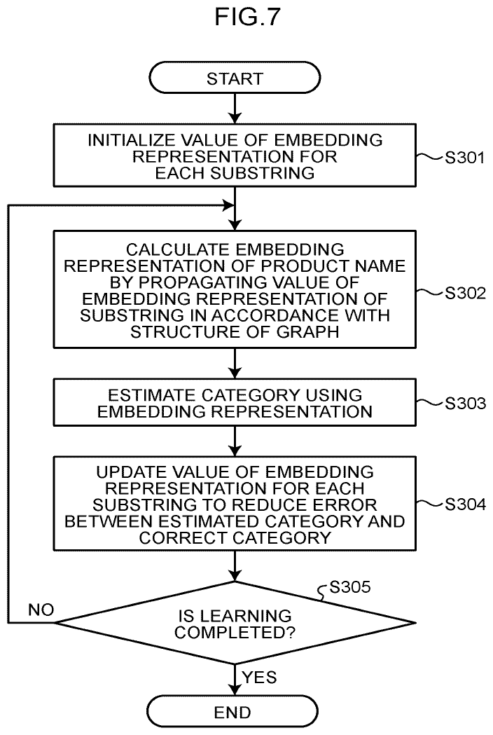

FIG. 7 is a flowchart illustrating an example of the learning processing performed by the learning unit 105.

The learning unit 105 initializes the value of the embedding representation F1 for each of one or more substrings PT2 (step S301). The calculation unit 104 calculates the embedding representation F2 for each product name by propagating the value of the embedding representation F1 in accordance with the structure of the graph generated by the graph generation unit 103 (step S302). Propagating the value of the embedding representation F1 refers to, for example, calculating the embedding representation F2 of the product name corresponding to a product name node connected to one or more substring nodes included in the graph by adding the values of the embedding representations F1 of the substrings corresponding to those nodes.

The learning unit 105 estimates the category by inputting the calculated embedding representation F2 of the product name into the estimation model EMA (step S303). For example, the learning unit 105 outputs the category with the highest probability output by the estimation model EMA as the estimation result.

The learning unit 105 updates the value of the embedding representation of each substring so that the estimated category matches the correct category (step S304).

The learning unit 105 assesses whether or not to complete the learning (step S305). If it is assessed not to complete the learning (step S305: No), the learning unit 105 returns to step S302 and repeats the processing. If it is assessed to complete the learning (step S305: Yes), the learning unit 105 completes the learning processing. For example, the learning unit 105 assesses to complete the learning in the case where the matching rate is equal to or greater than a threshold THB (matching rate threshold) or in the case where the number of repetitions of steps S302 to S305 exceeds a threshold THC (repetition count threshold).

Reference is made again to FIG. 1. The estimation unit 106 executes category estimation processing using the trained embedding representations. For the estimation processing, a procedure similar to the learning processing is executed for input information ID2, which includes the product name to be estimated for the category, up to the calculation of the embedding representation F2.

For example, the acquisition unit 101 acquires the input information ID2. The extraction unit 102 extracts one or more substrings PT3 (third substring) included in the product name contained in the input information ID2. The calculation unit 104 calculates the embedding representation F2 representing the characteristics of the product name included in the input information ID2, using the embedding representation F1 representing the characteristics of the extracted substring PT3.

The estimation unit 106 executes the estimation processing of estimating the category of the product name using the embedding representation F2 calculated as described above. For example, the estimation unit 106 estimates the category from the embedding representation F2 using the same estimation model as the estimation model EMA used by the learning unit 105.

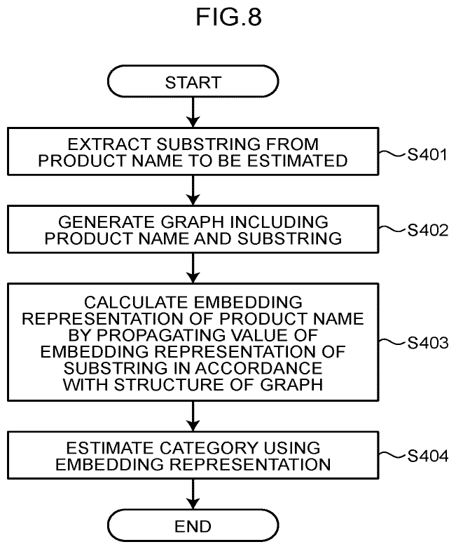

FIG. 8 is a flowchart illustrating an example of the estimation processing performed by the estimation unit 106.

The extraction unit 102 extracts a substring from the product name to be estimated (step S401). The graph generation unit 103 generates a graph including the product name and the extracted substring (step S402). The calculation unit 104 calculates the embedding representation F2 for each product name by propagating the value of the embedding representation F1 in accordance with the structure of the graph generated by the graph generation unit 103 (step S403).

The estimation unit 106 estimates a category by inputting the calculated embedding representation F2 of the product name into the estimation model EMA (step S404).

For example, the estimation unit 106 outputs the category with the highest probability output by the estimation model EMA as the estimation result.

Reference is made again to FIG. 1. The output control unit 111 controls the output of various types of information used by the information processing device 100. For example, the output control unit 111 causes the category estimated by the estimation unit 106 to be output. Any method can be used to output the information, and examples of applicable methods include displaying the information on a display device and transmitting the information to an external device via a network.

At least some of the components mentioned above (the acquisition unit 101, the extraction unit 102, the graph generation unit 103, the calculation unit 104, the learning unit 105, the estimation unit 106, and the output control unit 111) can be implemented by one or more processors. The components mentioned above can be implemented, for example, one or more processors. For example, the components mentioned above can be implemented by causing a processor such as a central processing unit (CPU) and a graphics processing unit (GPU) to execute a program, that is, by software. The components mentioned above can be implemented by a processor such as a dedicated integrated circuit (IC), that is, by hardware. The components mentioned above can be implemented by a combination of software and hardware. In the case of employing multiple processors, each processor can implement one of the components, or two or more of the components.

Further, the information processing device 100 can be physically configured as a single device or a plurality of devices. For example, the information processing device 100 can be constructed in a cloud environment. In addition, each component in the information processing device 100 can be distributed and provided in a plurality of devices. For example, the information processing device 100 (information processing system) can be configured to include a device (e.g., a learning device) equipped with the function necessary for learning (such as the learning unit 105) and a device (e.g., an estimation device) equipped with the estimation function (such as the estimation unit 106).

As described above, the information processing device according to the first embodiment trains a feature value of a substring using a category name (category string) obtained in advance and estimates the category of a product specified as an estimation target using the trained feature value. This makes it possible to estimate the category of a product with higher accuracy.

### Second Embodiment

In the first embodiment, a graph is generated in such a manner as to include all substrings PT2 included in the product name among the substrings 122 (substring PT2) stored in the storage unit 120. The plurality of substrings PT2 includes overlapping strings in some cases. In the example of FIG. 6, the substrings “bro” and “broccoli” included in the substring group 611 include the overlapping string “bro”. Additionally, the substrings “tartare” and the substrings “tar” included in the substring group 611 include the overlapping string “tar”. Since such overlapping strings can be included, if a graph is generated so as to include all substrings PT2 included in the product name, the strings included in the graph become redundant, and the accuracy of category estimation is likely to decrease.

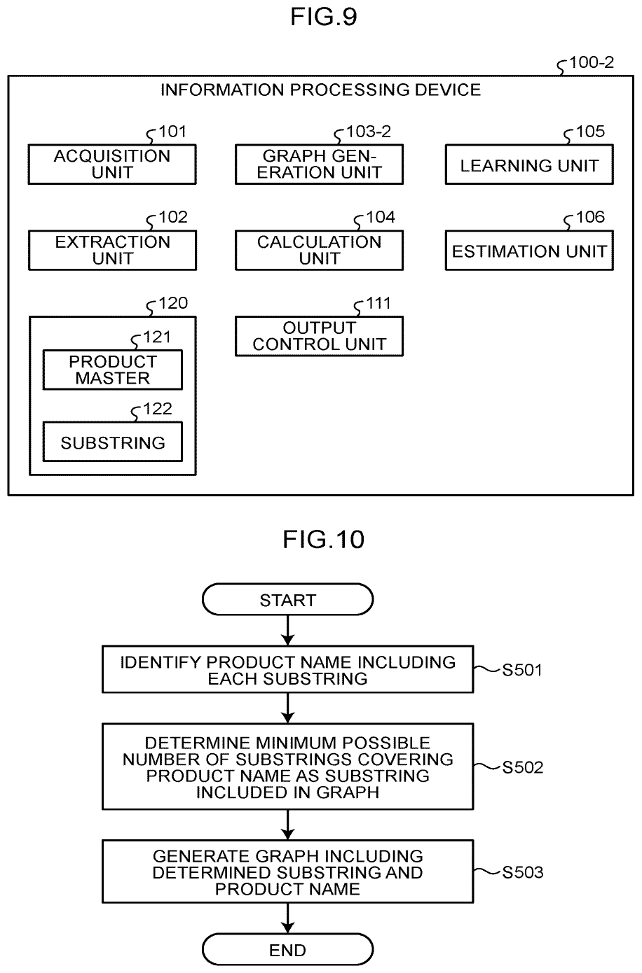

Thus, an information processing device according to a second embodiment determines the substring to be included in the graph to avoid redundancy. FIG. 9 is a block diagram illustrating an example of the configuration of an information processing device 100-2 according to the second embodiment. As illustrated in FIG. 9, the information processing device 100-2 includes a storage unit 120, an acquisition unit 101, an extraction unit 102, a graph generation unit 103-2, a calculation unit 104, a learning unit 105, an estimation unit 106, and an output control unit 111.

In the second embodiment, the function of the graph generation unit 103-2 is different from that of the first embodiment. The other configurations and functions are similar to those in FIG. 1, which is a block diagram of the information processing device 100 of the first embodiment, so they are denoted by the same reference numerals, and a description thereof is omitted herein.

The graph generation unit 103-2 determines the substring PT2 to be included in the graph for each product name so as to avoid redundancy. For example, the graph generation unit 103-2 determines, for each product name included in the plurality of pieces of input information ID1, the substring PT2 included in a combination in which the number of characters in the product name that match the characters in the substring PT2 is greater than in other combinations and the number of substrings PT2 in the combination is smaller than in other combinations, among one or more combinations of substrings PT2 included in the product name. This determination method can be understood as a method of determining the substring PT2 so as to cover the product name with the minimum possible number of substring combinations.

More specifically, the graph generation unit 103-2 can determine the substring PT2 as follows. In other words, the graph generation unit 103-2 executes determination processing of determining, from one or more substrings PT2, a substring PT2 in which the number of characters in the product name that match the characters included in the substring PT2 is greater than that of other substrings PT2, starting from a scanning start position (at least one of the beginning and the end) of the product name. The graph generation unit 103-2 repeats the determination processing, using a string obtained by removing the determined substring PT2 from the product name as a new product name. The determination processing is repeatedly executed, for example, until none of the substrings PT2 are included in the product name.

FIG. 10 is a flowchart illustrating an example of graph generation processing in the second embodiment.

The graph generation unit 103-2 identifies the product name including the substring PT2 for each of the extracted one or more substrings PT2 (step S501). The graph generation unit 103-2 determines, for each product name included in the product master 121, the minimum possible number of substrings that cover the product name as the substrings PT2 to be included in the graph (step S502). The graph generation unit 103-2 generates a graph including the determined substring and the product name (step S503) and then completes the graph generation processing.

A specific example of the graph generation processing in the present embodiment is now described. An example of the graph generation processing for the product name 601 “shrimp's and broccoli's tartare”, similar to FIG. 6, is illustrated. The scanning start position is assumed to be the beginning of the product name 601.

In this case, the substring “shrimp's” is determined as a first substring PT2. The string obtained by removing the substring “shrimp's” from the product name 601 is set as a new product name. If the particle “'s” is also removed, the new product name becomes “Broccoli Tartare”.

In the case where the new product name “broccoli tartare” is scanned from the beginning, the candidates for the matching substring PT2 are the substrings “broccoli” and “bro”. Among these two substrings, the substring “broccoli”, in which the number of characters in the product name that match the characters included in the substring PT2 is larger, is determined as the next substring PT2. Similarly, among the substrings “tartare” and “tar”, the substring “tartare”, in which the number of characters in the product name that match the characters included in the substring PT2 is larger, is determined as the next substring PT2.

In the example mentioned above, the scanning start position is assumed to be the beginning, but the scanning start position can be the end, or both the beginning and the end. In the latter case, for example, a graph is generated that includes both a substring PT2 determined with the scanning start position as the beginning and a substring PT2 determined with the scanning start position as the end.

As described above, in the information processing device according to the second embodiment, it is possible to determine the substring to be included in the graph so as to avoid redundancy. This makes it possible to estimate the category with higher accuracy.

### Third Embodiment

In the embodiments mentioned above, the embedding representation of each product name is calculated based on the relationship between the product name and the substring. On the other hand, the calculation of the embedding representation of the product name can also be implemented by other methods. A typical method is an approach using a language model such as an LLM. An information processing device according to a third embodiment further uses a feature value calculated using the language model to train the feature value and estimates the category using the trained feature value.

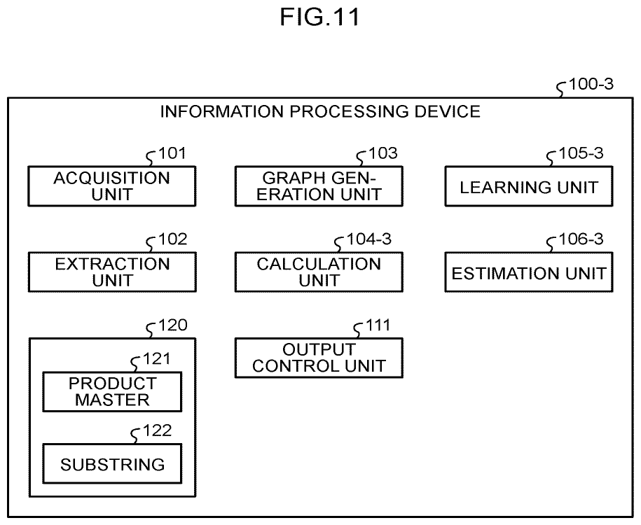

FIG. 11 is a block diagram illustrating an example of the configuration of an information processing device 100-3 according to the third embodiment. As illustrated in FIG. 11, the information processing device 100-3 includes a storage unit 120, an acquisition unit 101, an extraction unit 102, a graph generation unit 103, a calculation unit 104-3, a learning unit 105-3, an estimation unit 106-3, and an output control unit 111.

In the third embodiment, the functions of the calculation unit 104-3, the learning unit 105-3, and the estimation unit 106-3 are different from those of the first embodiment. The other configurations and functions are similar to those in FIG. 1, which is a block diagram of the information processing device 100 of the first embodiment, so they are denoted by the same reference numerals, and a description thereof is omitted herein.

The calculation unit 104-3 is different from the calculation unit 104 of the embodiments mentioned above in that it is further equipped with a function of calculating an embedding representation F3 (third feature information) of a product name using a language model. The language model is a model trained to receive a product name as input and output the embedding representation F3 of the product name.

The learning unit 105-3 executes the learning processing to increase the matching rate between a category estimated using the embedding representation F3 and the embedding representation F2 and a category represented by a category name (category string) corresponding to the product name in the product master 121.

For example, the learning unit 105-3 estimates the probability of each of a plurality of categories from the embedding representation F2 using the estimation model EMA in a similar procedure to the embodiment mentioned above. Furthermore, the learning unit 105-3 estimates the probability of each of a plurality of categories from the embedding representation F3 using an estimation model EMB. The estimation model EMB is a model trained to receive, for example, the embedding representation F3 as input and output the probability of each of a plurality of categories. The learning unit 105-3 calculates a category estimation result for the product name by adding the probabilities calculated for the respective embedding representations F2 and F3 for the respective categories.

The number of dimensions of the embedding representation F3 output by the language model does not necessarily match the number of dimensions of the embedding representation F2. For this reason, as in the example mentioned above, the learning unit 105-3 calculates the probabilities of multiple categories from the embedding representation F3 using the estimation model EMB different from the estimation model EMA which receives the embedding representation F2 as input. If the number of dimensions of the embedding representation F2 and the number of dimensions of the embedding representation F3 match, the learning unit 105-3 can execute the procedure mentioned above using the estimation model EMA instead of the estimation model EMB. The learning unit 105-3 can calculate the category estimation result for the product name by inputting a value obtained by adding the embedding representation F2 and the embedding representation F3 into the estimation model EMA.

The estimation unit 106-3 estimates a category using the embedding representation F3 and the embedding representation F2. The estimation unit 106-3 can estimate a category using the embedding representation F3 and the embedding representation F2 by a similar method to the learning unit 105-3.

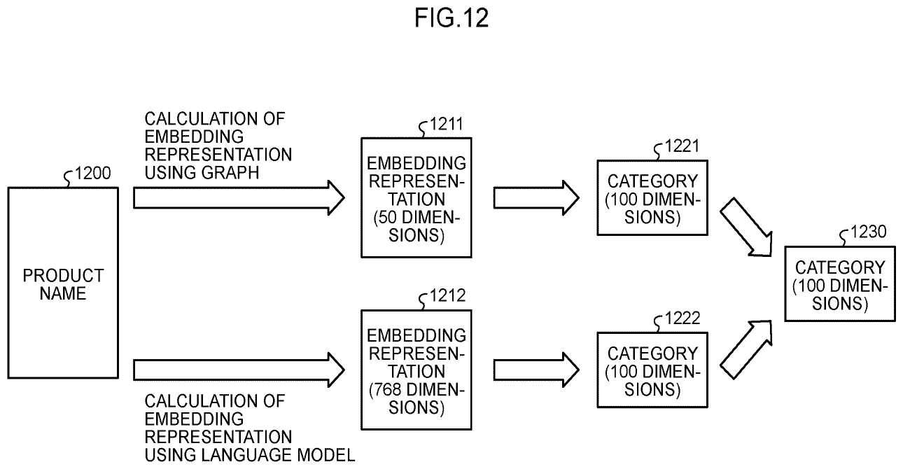

FIG. 12 is a diagram illustrating an example of a category estimation method by the learning unit 105-3 and the estimation unit 106-3. The following description is given taking the learning unit 105-3 as an example, but a similar procedure is also applied to the estimation unit 106-3.

The calculation unit 104-3 calculates an embedding representation 1211 (embedding representation F2) from a product name 1200 using a graph. Furthermore, the calculation unit 104-3 calculates an embedding representation 1212 (embedding representation F3) from the product name 1200 using a language model. In FIG. 12, an example is illustrated in which the embedding representation 1211 has 50 dimensions and the embedding representation 1212 has 768 dimensions.

The learning unit 105-3 inputs the embedding representation 1211 into the estimation model EMA and obtains an estimation result 1221 that indicates the probability of each category. Furthermore, the learning unit 105-3 inputs the embedding representation 1212 into the estimation model EMB and obtains an estimation result 1222 that indicates the probability of each category. FIG. 12 illustrates an example in which the number of categories is 100.

The learning unit 105-3 calculates a final estimation result 1230 of the category for the product name 1200 by adding the estimation result 1221 and the estimation result 1222.

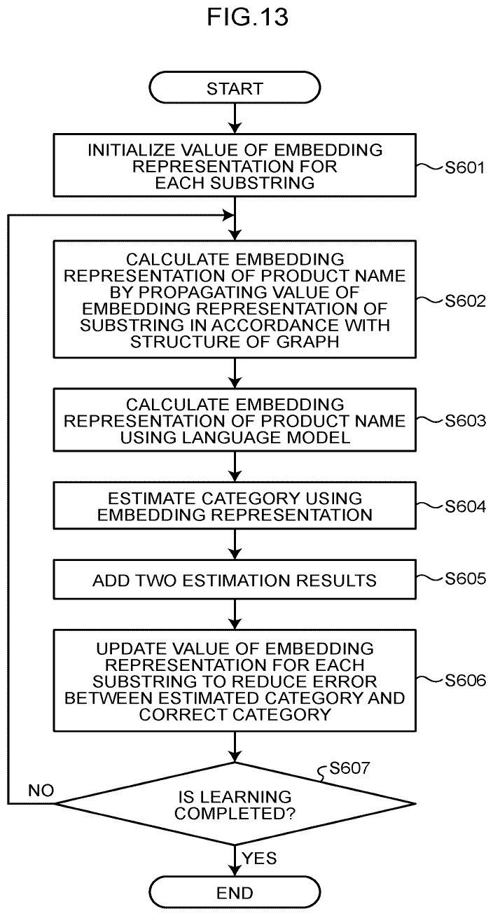

Next, the learning processing by the information processing device 100-3 according to the third embodiment is now described with reference to FIG. 13. FIG. 13 is a flowchart illustrating an example of the learning processing in the third embodiment.

The processing in steps S601 to S602 is similar to that in steps S301 to S302 of the information processing device 100 according to the first embodiment, so a description thereof is omitted herein.

In the present embodiment, the calculation unit 104-3 calculates the embedding representation F3 for each product name using the language model (step S603). The learning unit 105-3 estimates a category by inputting the embedding representation F2 into the estimation model EMA and also estimates a category by inputting the embedding representation F3 into the estimation model EMB (step S604). The learning unit 105-3 calculates a final estimation result for each product name by adding the estimation results of the two categories (step S605).

The processing in steps S606 to S607 is similar to that in steps S304 to S305 of the information processing device 100 according to the first embodiment, so a description thereof is omitted herein.

Up to this point, an example using one language model has been described. The number of language models is not limited to one and can be two or more.

As described above, in the third embodiment, it is possible to train a feature value by further using the feature value calculated using a language model, and to estimate a category using the trained feature value.

### Fourth Embodiment

In the embodiment mentioned above, the sum (or average) of the embedding representations of the substrings included in the product name is calculated as the embedding representation of the product name. On the other hand, for example, in the case of a product name in Japanese, the substring included later in the product name often contains important information for estimating the category. An information processing device according to a fourth embodiment calculates a feature value (embedding representation) of a product name using a weight depending on the occurrence position of a substring in a product name.

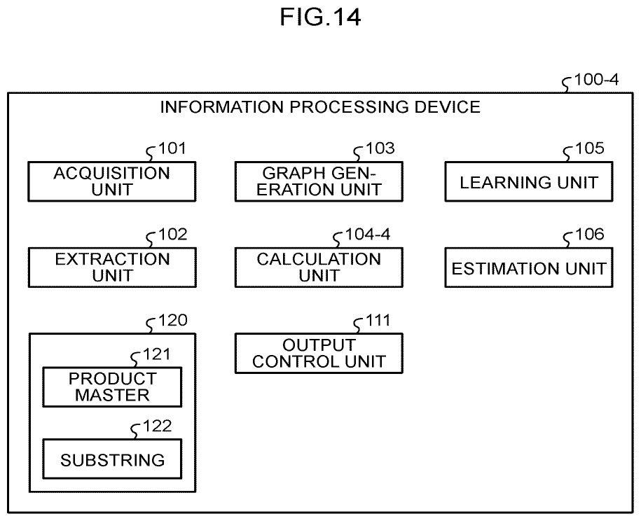

FIG. 14 is a block diagram illustrating an example of the configuration of an information processing device 100-4 according to the fourth embodiment. As illustrated in FIG. 14, the information processing device 100-4 includes a storage unit 120, an acquisition unit 101, an extraction unit 102, a graph generation unit 103, a calculation unit 104-4, a learning unit 105, an estimation unit 106, and an output control unit 111.

In the fourth embodiment, the function of the calculation unit 104-4 is different from that of the first embodiment. The other configurations and functions are similar to those in FIG. 1, which is a block diagram of the information processing device 100 of the first embodiment, so they are denoted by the same reference numerals, and a description thereof is omitted herein.

The calculation unit 104-4 calculates the embedding representation F2 of the product name based on the embedding representation F1 of one or more substrings PT2 included in the product name, in which the embedding representation F1 is weighted depending on the occurrence position of the substring PT2 in the product name.

For example, in the case where the product name is “shrimp and broccoli salad”, it is often considered more appropriate that the category of the product name is the “salad” category rather than the “shrimp” category. Thus, rather than simply calculating the sum (or average) of the embedding representation of the substring, it is expected that the category estimation accuracy can be improved by changing the weight of the substring depending on the occurrence position. For example, the calculation unit 104-4 calculates the weight such that the closer the occurrence position of the substring PT2 is to the beginning of the product name, the smaller the value becomes, and the closer it is to the end, the larger the value becomes. As such a weight, for example, the ratio of the occurrence position of the last character of the substring to the length of the product name (number of strings) can be used. In the example mentioned above, the weight of the substring “shrimp” is approximately (2/13)≈0.15, and the weight of the substring “salad” is (13/13)=1.

The calculation unit 104-4 can calculate a normalized weight such that the sum of weighting values for each product becomes 1. The weight can be calculated by “ratio×constant CA+constant CB”, where the above-mentioned ratio is used. The weight can be calculated by a normalized value of “ratio×constant CA+constant CB”, where the above-mentioned ratio is used. The constants CA and CB can be set so that the category estimation accuracy is optimized using a machine learning technique such as deep learning.

The method of calculating the weight can be changed depending on the language to be employed. For example, in the case of English, a substring closer to the beginning of a product name is considered to have a higher correlation with the category. In such a case, a weighting value can be used so that the closer the occurrence position is to the beginning of the product name, the larger the value; and the closer it is to the end, the smaller the value.

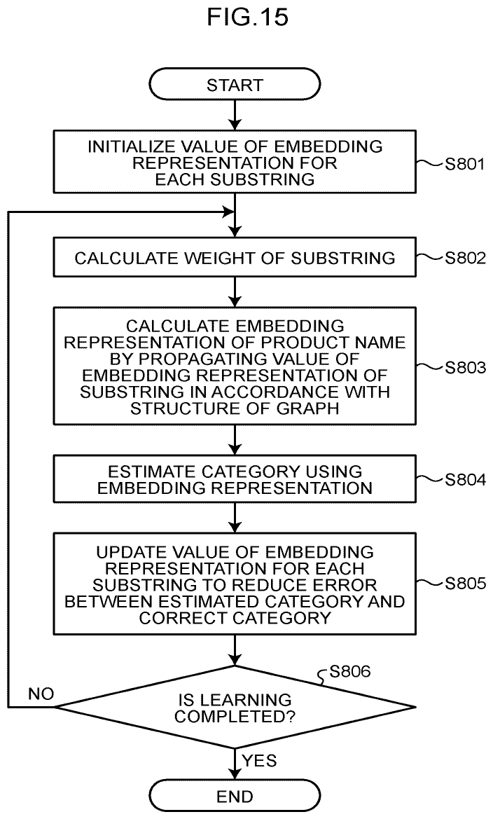

Next, information processing by the information processing device 100-4 according to the fourth embodiment is now described with reference to FIG. 15. FIG. 15 is a flowchart illustrating an example of information processing in the fourth embodiment.

The processing in step S801 is similar to that in step S301 of the information processing device 100 according to the first embodiment, and thus a description thereof is omitted.

The calculation unit 104-4 calculates the weight of the substrings (step S802). The calculation unit 104-4 calculates the embedding representation F2 for each product name (step S803). In this case, the calculation unit 104-4 calculates the embedding representation F2 for the node corresponding to the product name by adding values obtained by multiplying the embedding representation F1 of the substring, which corresponds to one or more substring nodes included in the graph, by the weight corresponding to the relevant embedding representation F1.

The processing in steps S804 to S806 is similar to that in steps S303 to S305 of the information processing device 100 according to the first embodiment, and thus a description thereof is omitted.

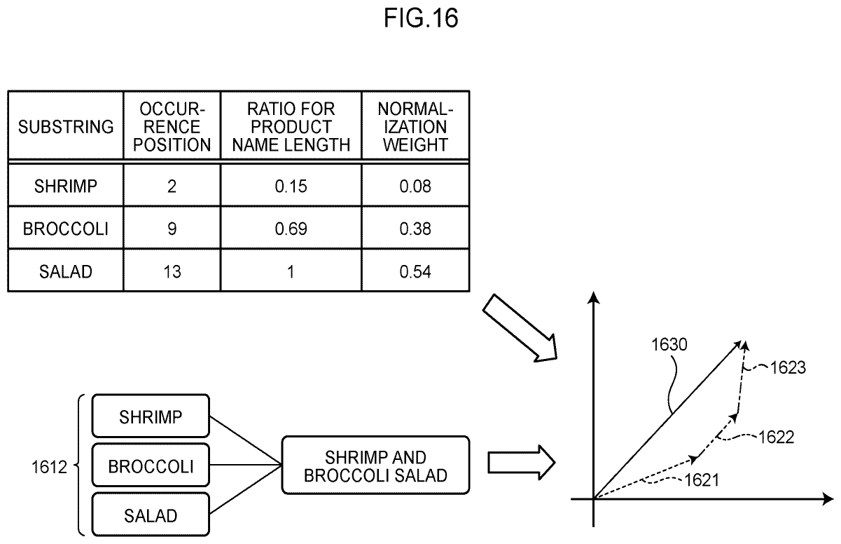

FIG. 16 is a diagram illustrating an example of calculating the embedding representation F2 according to the present embodiment. FIG. 16 is an example of the calculation of the embedding representation F2 for the product name “shrimp and broccoli salad”. In the example of FIG. 16, a normalized weight is used.

For example, for the substring “shrimp”, the ratio to the length of the product name is 0.15, and the weight becomes 0.08 through normalization. The calculation unit 104-4 calculates the embedding representation F2 for the product name “shrimp and broccoli salad” in accordance with the weights of the respective substrings and a graph 1612, as follows:

Embedding Representation F2=embedding representation for “shrimp”×0.08+embedding representation for “broccoli”×0.38+embedding representation for “salad”×0.54

The graph at the lower right of FIG. 16 is a graph that schematically illustrates the addition of embedding representations. Embedding representations 1621, 1622, and 1623 correspond to, for example, the values obtained by multiplying the embedding representations of “shrimp”, “broccoli”, and “salad” by their respective weights. By adding these values, an embedding representation 1630, which is the embedding representation F2 of the product name “shrimp and broccoli salad”, is calculated.

Such processing makes it possible to distinguish, for example, between two product names that include the same substring “salad”, one in which “salad” occurs in the first half and another in which “salad” occurs in the second half.

As described above, in the fourth embodiment, the feature value (embedding representation) of the product name is calculated using a weight corresponding to the position of the substring in the product name. This makes it possible to further improve the accuracy of category estimation.

### Fifth Embodiment

An information processing device according to a fifth embodiment modifies the probability of a category by referring to a hierarchical structure or the like among categories. This probability modification can be applied both during learning and during estimation. The following mainly describes an example of modification performed during estimation.

The number of categories for product names (number of categories) can be large in some cases. In such cases, there is a concern that the estimation accuracy will decrease if the respective categories are estimated independently. On the other hand, in the case where the number of categories is large, multiple categories are often related to each other. For example, if a fish category, a tuna category, and a salmon category exist, the fish category corresponds to a superordinate concept category of the tuna category and the salmon category.

By utilizing such information regarding the hierarchical structure between categories, an improvement in the category estimation accuracy can be expected. In the present embodiment, for example, instead of using the probability that each product belongs to the fish category as it is, the estimated probability of the fish category is calculated by a linear sum of the probability that the product belongs to the salmon category, which is a subordinate concept of the fish category, and the probability that the product belongs to the tuna category.

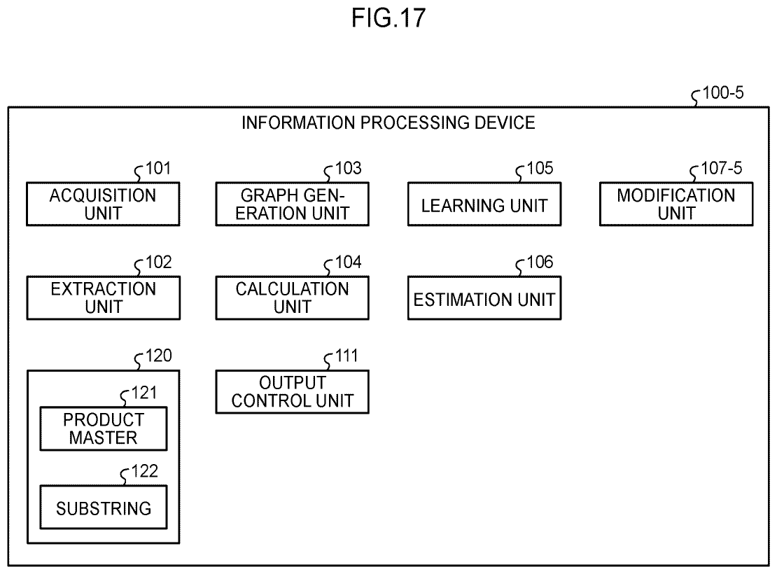

FIG. 17 is a block diagram illustrating an example of the configuration of an information processing device 100-5 according to the fifth embodiment. As illustrated in FIG. 17, the information processing device 100-5 includes a storage unit 120, an acquisition unit 101, an extraction unit 102, a graph generation unit 103, a calculation unit 104, a learning unit 105, an estimation unit 106, a modification unit 107-5, and an output control unit 111.

The fifth embodiment differs from the first embodiment in that a modification unit 107-5 is added. The other configurations and functions are similar to those in FIG. 1, which is a block diagram of the information processing device 100 of the first embodiment, so they are denoted by the same reference numerals, and a description thereof is omitted herein.

The modification unit 107-5 modifies the probabilities of at least some of the multiple categories that are output by the estimation model EMA used by the learning unit 105 and the estimation unit 106. For example, in the case where a category CTA (first category) among the multiple categories is a superordinate concept of one or more categories CTB (second category) among the multiple categories, the modification unit 107-5 modifies the probability of the category CTA to a linear sum of the probabilities of the one or more categories CTB.

Instead of the linear sum, an average value can be used. Furthermore, the weights used in calculating the linear sum can be set using artificial intelligence (AI) techniques such as deep learning.

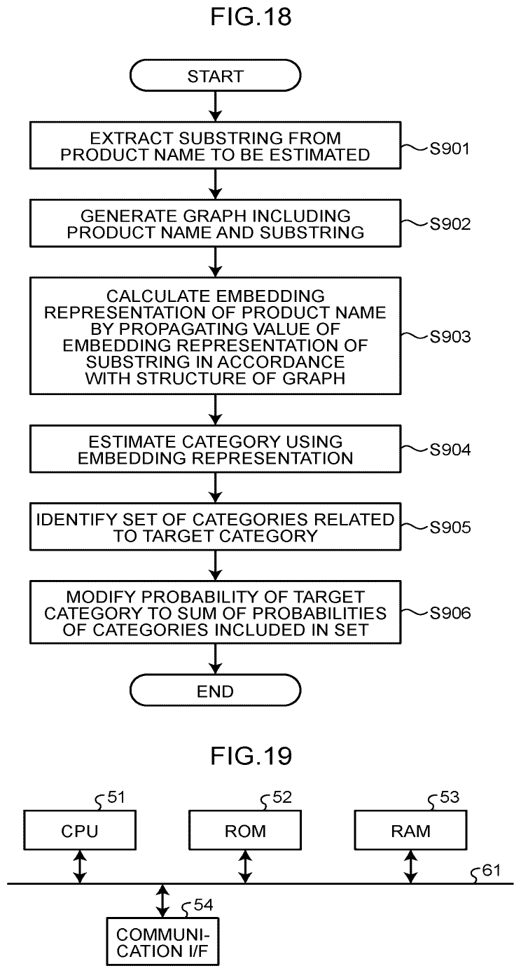

Next, the estimation processing by the information processing device 100-5 according to the fifth embodiment is described with reference to FIG. 18. FIG. 18 is a flowchart illustrating an example of the estimation processing in the fifth embodiment.

The processing in steps S901 to S904 is similar to that in steps S401 to S404 of the information processing device 100 according to the first embodiment, and thus a description thereof is omitted.

The modification unit 107-5 identifies a set of categories related to a target category (step S905). The target category is, for example, a category designated as a target for which the probability is to be modified and corresponds to the above-mentioned category CTA. For example, the modification unit 107-5 identifies one or more categories (category CTB) corresponding to a subordinate concept of the target category (category CTA) by referring to information that indicates a hierarchical relationship between a plurality of categories. The set of categories CTB corresponds to a set of categories related to the target category. The modification unit 107-5 modifies the probability of the target category (category CTA) to a linear sum of the probabilities of the category CTB included in the set (step S906) and then completes the estimation processing.

The target category is not limited to a category that corresponds to a superordinate concept. For example, the target category can be a category indicating that the product does not belong to any category (hereinafter, the other category). In many cases, the other category does not have a substring specific to the relevant category, and it is difficult to identify products that belong to the other category with high accuracy. On the other hand, if the probability of belonging to a category other than the other category is low, it can be considered that the probability of belonging to the other category is high.

For example, the modification unit 107-5 identifies one or more categories designated as categories belonging to the other category. The modification unit 107-5 calculates the probability of the other category by a linear sum of the probabilities of the identified one or more categories.

As described above, the information processing device according to the fifth embodiment makes it possible to modify the probability of a category by referring to the hierarchical structure between categories.

The category estimation results obtained by each of the embodiments mentioned above can be used, for example, as follows.

### First Application Example

If the maximum value among the probabilities of the respective categories does not reach a specified threshold THD (second threshold), it can be considered that the product (product name) to be estimated does not belong to any of the specified multiple categories and is highly likely to belong to a new category or other categories.

Thus, for example, in the case where the probability of each of the multiple categories is smaller than the threshold THD, the estimation unit 106 can assess that the category of the product name is not included in the multiple categories.

If the maximum value among the probabilities of the respective categories does not reach the specified threshold THD, it can be understood that the category fails to be estimated with high accuracy using the method of the embodiment. Thus, in such a case, the selection (labeling) of a category for the product name by an expert or the like can be performed. For example, the output control unit 111 can cause information indicating that the target product name is not included in any category to be output. This makes it possible to prompt processing such as labeling by an expert.

### Second Application Example

If the probabilities of multiple categories have multiple peaks, the target product name can, in some cases, be considered to belong to a new category that combines elements of multiple categories corresponding to those peaks.

Thus, for example, the estimation unit 106 can generate a single category CTD (fourth category) by integrating two or more categories CTC (third category) in the case where the probability for two or more categories CTC among the multiple categories is equal to or greater than a threshold PHE (first threshold).

### Third Application Example

By comparing the category name in the product master 121 with the category name of the category estimated according to the embodiment, it is possible to detect an error pattern related to the estimation of which categories exist.

For example, the estimation unit 106 can identify an error pattern by comparing the category estimated by the estimation processing of the embodiment with the category indicated by the category name in the product master 121 (correct category). The output control unit 111 can cause the identified pattern to be output.

### Fourth Application Example

Even if the correct matching rate of category estimation for each of a large number of products is low, the correct matching rate of category estimation can, in some cases, be improved by limiting the products to those for which the maximum value among the probabilities of the respective categories is equal to or greater than the threshold PHF (third threshold). To enable the determination of such a situation, for example, the learning unit 105 can calculate the proportion of correct products among the products for which the maximum value of the probabilities of each category is equal to or greater than the threshold PHF (third threshold). The output control unit 111 can output information that visualizes the calculated proportion.

As described above, according to the first to fifth embodiments, it is possible to estimate the category of a target object such as a product with higher accuracy.

Next, the hardware configuration of the information processing device according to the first to fifth embodiments is described with reference to FIG. 19. FIG. 19 is a diagram illustrated to describe an example of the hardware configuration of the information processing devices according to the first to fifth embodiments.

The information processing devices according to the first to fifth embodiments include a control device such as a central processing unit (CPU) 51, a storage device such as a read-only memory (ROM) 52 and a random-access memory (RAM) 53, a communication I/F 54 that provides a connection to a network for communication, and a bus 61 that provides a connection to each component.

The program executed by the information processing devices according to the first to fifth embodiments is provided by being pre-installed in the ROM 52 or the like.

The program executed by the information processing devices according to the first to fifth embodiments can be provided as a computer program product by being recorded on a computer-readable recording medium such as a compact disk read-only memory (CD-ROM), a flexible disk (FD), a compact disk-recordable (CD-R), or a digital versatile disk (DVD) in an installable or executable file format.

Furthermore, the program executed by the information processing devices according to the first to fifth embodiments can be configured to be provided by being stored on a computer connected to a network such as the Internet and downloaded via the network. Additionally, the program executed by the information processing devices according to the first to fifth embodiments can be provided or distributed via a network such as the Internet.

The program executed by the information processing devices according to the first to fifth embodiments can cause the computer to function as each component of the information processing device described above. This computer allows the CPU 51 to load a program from a computer-readable storage medium onto the main storage device and execute it.

Configuration Examples of an embodiment are described below:

### Configuration Example 1

An information processing device comprising
one or more hardware processors configured to:
   extract, for each of a plurality of pieces of first input information including a target string representing a target and a category string representing a category to which the target belongs, one or more first substrings included in the target string, and extract, from the one or more first substrings included in the target string, one or more second substrings using the category string;
   determine, for each of the plurality of pieces of first input information, one or more second substrings associated with the target string included in the first input information; and
   execute learning processing to train first feature information and second feature information to increase a matching rate between a category of the target string estimated from the second feature information and a category represented by the category string, the first feature information representing a feature of the determined one or more second substrings, the second feature information representing a feature of the target string including the determined one or more second substrings, the second feature information being calculated based on the first feature information.

### Configuration Example 2

The information processing device according to Configuration Example 1, wherein
the one or more hardware processors are configured to
   extract, for each of the one or more first substrings, as the one or more second substrings, the first substring having a determination value higher than a determination value of another first substring, the determination value being at least one of numbers of the corresponding target strings among one or more category strings corresponding to the target strings including the first substring, and a ratio of the number to a total number of the target strings including the first substring.

### Configuration Example 3

The information processing device according to Configuration Example 1 or 2, wherein
the one or more hardware processors are configured to
   extract one or more substrings included in the category string as the first substring.

### Configuration Example 4

The information processing device according to any one of Configuration Examples 1 to 3, wherein
the one or more hardware processors are configured to:
   generate a graph including the target string and the determined second substring; and
   calculate the second feature information of the target string included in the graph based on the first feature information of the second substring included in the graph.

### Configuration Example 5

The information processing device according to any one of Configuration Examples 1 to 4, wherein
the one or more hardware processors are configured to
   determine, for each of the target strings included in the plurality of pieces of first input information, the second substring included in a combination among combinations of the one or more second substrings included in the target string, the combination having a greater number of characters within the target string that match characters included in the second substrings than another combination and having a smaller number of second substrings within the combination than other combinations.

### Configuration Example 6

The information processing device according to any one of Configuration Examples 1 to 4, wherein
the one or more hardware processors are configured to:
   execute determination processing of determining, from the one or more second substrings, the second substring having a greater number of characters within the target string that match characters included in the second substring than another second substring, starting from a scanning start position that is at least one of a beginning and an end of the target string; and
   repeat the determination processing using, as a new target string, a string obtained by removing the determined second substring from the target string.

### Configuration Example 7

The information processing device according to any one of Configuration Examples 1 to 6, wherein
the one or more hardware processors are configured to
   calculate the second feature information of the target string based on the first feature information of the one or more second substrings included in the target string, that is weighted depending on a position at which the one or more second substrings included in the target string occur within the target string.

### Configuration Example 8

The information processing device according to any one of Configuration Examples 1 to 7, wherein
the one or more hardware processors are configured to:
   calculate third feature information of the target string including the extracted second substrings using a language model trained to receive the target string as input and to output the third feature information representing a feature of the target string; and
   execute the learning processing to increase a matching rate between a category of the target string estimated using the third feature information and the second feature information and a category represented by the category string.

### Configuration Example 9

The information processing device according to any one of Configuration Examples 1 to 8, wherein
the one or more hardware processors are configured to:
   extract, using second input information including the target string, one or more third substrings included in the target string included in the second input information;
   calculate the second feature information representing the feature of the target string included in the second input information based on the first feature information representing a feature of the extracted third substrings; and
   execute an estimation processing of estimating the category of the target string using the second feature information.

### Configuration Example 10

The information processing device according to Configuration Example 9, wherein
the one or more hardware processors are configured to:
   output a probability for each of a plurality of categories as a result of the estimation processing; and
   modify a probability of a first category among the plurality of categories to a linear sum of probabilities of one or more second categories in a case where the first category is a superordinate concept of the one or more second categories among the plurality of categories.

### Configuration Example 11

The information processing device according to Configuration Example 9, wherein
the one or more hardware processors are configured to:
   output a probability for each of a plurality of categories as a result of the estimation processing; and
   generate a single fourth category by integrating two or more third categories in a case where the probability for the two or more third categories among the plurality of categories is greater than or equal to a first threshold.

### Configuration Example 12

The information processing device according to Configuration Example 9, wherein
the one or more hardware processors are configured to:
   output a probability for each of a plurality of categories as a result of the estimation processing; and
   assess that the category of the target string is not included in the plurality of categories in a case where each of the probabilities of the plurality of categories is less than a second threshold.

### Configuration Example 13

The information processing device according to Configuration Example 9, wherein
the one or more hardware processors are configured to
   identify an error pattern by comparing a category estimated by the estimation processing with a correct category.

### Configuration Example 14

The information processing device according to any one of Configuration Examples 1 to 13, wherein
the one or more hardware processors are configured to:
   estimate a probability for each of a plurality of categories from the second feature information; and
   calculate a proportion of correct targets among targets having a probability greater than or equal to a third threshold.

### Configuration Example 15

The information processing device according to any one of Configuration Examples 1 to 14, wherein
the one or more hardware processors are configured to:
   execute predetermined preprocessing on at least a portion of the plurality of pieces of first input information; and
   execute, for each of the plurality of pieces of first input information subjected to the preprocessing, extraction of the first substring and extraction of the second substring.

### Configuration Example 16

An information processing device comprising
one or more hardware processors configured to:
   extract one or more substrings included in a target string representing a target using input information including the target string;
   calculate second feature information representing a feature of the target string based on first feature information representing a feature of the extracted substrings; and
   execute estimation processing of estimating a category of the target string using the second feature information.

### Configuration Example 17

An information processing method executed by an information processing device, the method comprising:
extracting, for each of a plurality of pieces of first input information including a target string representing a target and a category string representing a category to which the target belongs, one or more first substrings included in the target string, and extracting, from the one or more first substrings included in the target string, one or more second substrings using the category string;
determining, for each of the plurality of pieces of first input information, one or more second substrings associated with the target string included in the first input information; and
executing learning processing to train first feature information and second feature information to increase a matching rate between a category of the target string estimated from the second feature information and a category represented by the category string, the first feature information representing a feature of the determined one or more second substrings, the second feature information representing a feature of the target string including the determined one or more second substrings, the second feature information being calculated based on the first feature information.

### Configuration Example 18

A program causing a computer to execute:
extracting, for each of a plurality of pieces of first input information including a target string representing a target and a category string representing a category to which the target belongs, one or more first substrings included in the target string, and extracting, from the one or more first substrings included in the target string, one or more second substrings using the category string;
determining, for each of the plurality of pieces of first input information, one or more second substrings associated with the target string included in the first input information; and
executing learning processing to train first feature information and second feature information to increase a matching rate between a category of the target string estimated from the second feature information and a category represented by the category string, the first feature information representing a feature of the determined one or more second substrings, the second feature information representing a feature of the target string including the determined one or more second substrings, the second feature information being calculated based on the first feature information.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising
one or more hardware processors configured to:
extract, for each of a plurality of pieces of first input information including a target string representing a target and a category string representing a category to which the target belongs, one or more first substrings included in the target string, and extract, from the one or more first substrings included in the target string, one or more second substrings using the category string;
determine, for each of the plurality of pieces of first input information, one or more second substrings associated with the target string included in the first input information; and
execute learning processing to train first feature information and second feature information to increase a matching rate between a category of the target string estimated from the second feature information and a category represented by the category string, the first feature information representing a feature of the determined one or more second substrings, the second feature information representing a feature of the target string including the determined one or more second substrings, the second feature information being calculated based on the first feature information.

2. The device according to claim 1, wherein
the one or more hardware processors are configured to
extract, for each of the one or more first substrings, as the one or more second substrings, the first substring having a determination value higher than a determination value of another first substring, the determination value being at least one of numbers of the corresponding target strings among one or more category strings corresponding to the target strings including the first substring, and a ratio of the number to a total number of the target strings including the first substring.

3. The device according to claim 1, wherein
the one or more hardware processors are configured to
extract one or more substrings included in the category string as the first substring.

4. The device according to claim 1, wherein
the one or more hardware processors are configured to:
generate a graph including the target string and the determined second substring; and
calculate the second feature information of the target string included in the graph based on the first feature information of the second substring included in the graph.

5. The device according to claim 1, wherein
the one or more hardware processors are configured to
determine, for each of the target strings included in the plurality of pieces of first input information, the second substring included in a combination among combinations of the one or more second substrings included in the target string, the combination having a greater number of characters within the target string that match characters included in the second substrings than another combination and having a smaller number of second substrings within the combination than other combinations.

6. The device according to claim 1, wherein
the one or more hardware processors are configured to:
execute determination processing of determining, from the one or more second substrings, the second substring having a greater number of characters within the target string that match characters included in the second substring than another second substring, starting from a scanning start position that is at least one of a beginning and an end of the target string; and
repeat the determination processing using, as a new target string, a string obtained by removing the determined second substring from the target string.

7. The device according to claim 1, wherein
the one or more hardware processors are configured to
calculate the second feature information of the target string based on the first feature information of the one or more second substrings included in the target string, that is weighted depending on a position at which the one or more second substrings included in the target string occur within the target string.

8. The device according to claim 1, wherein
the one or more hardware processors are configured to:
calculate third feature information of the target string including the extracted second substrings using a language model trained to receive the target string as input and to output the third feature information representing a feature of the target string; and
execute the learning processing to increase a matching rate between a category of the target string estimated using the third feature information and the second feature information and a category represented by the category string.

9. The device according to claim 1, wherein
the one or more hardware processors are configured to:
extract, using second input information including the target string, one or more third substrings included in the target string included in the second input information;
calculate the second feature information representing the feature of the target string included in the second input information based on the first feature information representing a feature of the extracted third substrings; and
execute an estimation processing of estimating the category of the target string using the second feature information.

10. The device according to claim 9, wherein
the one or more hardware processors are configured to:
output a probability for each of a plurality of categories as a result of the estimation processing; and
modify a probability of a first category among the plurality of categories to a linear sum of probabilities of one or more second categories in a case where the first category is a superordinate concept of the one or more second categories among the plurality of categories.

11. The device according to claim 9, wherein
the one or more hardware processors are configured to:
output a probability for each of a plurality of categories as a result of the estimation processing; and
generate a single fourth category by integrating two or more third categories in a case where the probability for the two or more third categories among the plurality of categories is greater than or equal to a first threshold.

12. The device according to claim 9, wherein
the one or more hardware processors are configured to:
output a probability for each of a plurality of categories as a result of the estimation processing; and
assess that the category of the target string is not included in the plurality of categories in a case where each of the probabilities of the plurality of categories is less than a second threshold.

13. The device according to claim 9, wherein
the one or more hardware processors are configured to
identify an error pattern by comparing a category estimated by the estimation processing with a correct category.

14. The device according to claim 1, wherein
the one or more hardware processors are configured to:
estimate a probability for each of a plurality of categories from the second feature information; and
calculate a proportion of correct targets among targets having a probability greater than or equal to a third threshold.

15. The device according to claim 1, wherein
the one or more hardware processors are configured to:
execute predetermined preprocessing on at least a portion of the plurality of pieces of first input information; and
execute, for each of the plurality of pieces of first input information subjected to the preprocessing, extraction of the first substring and extraction of the second substring.

16. An information processing device comprising
one or more hardware processors configured to:
extract one or more substrings included in a target string representing a target using input information including the target string;
calculate second feature information representing a feature of the target string based on first feature information representing a feature of the extracted substrings; and
execute estimation processing of estimating a category of the target string using the second feature information.

17. An information processing method executed by an information processing device, the method comprising:
extracting, for each of a plurality of pieces of first input information including a target string representing a target and a category string representing a category to which the target belongs, one or more first substrings included in the target string, and extracting, from the one or more first substrings included in the target string, one or more second substrings using the category string;
determining, for each of the plurality of pieces of first input information, one or more second substrings associated with the target string included in the first input information; and
executing learning processing to train first feature information and second feature information to increase a matching rate between a category of the target string estimated from the second feature information and a category represented by the category string, the first feature information representing a feature of the determined one or more second substrings, the second feature information representing a feature of the target string including the determined one or more second substrings, the second feature information being calculated based on the first feature information.

18. A computer program product comprising a non-transitory computer-readable medium including programmed instructions, the instructions causing a computer to execute:
extracting, for each of a plurality of pieces of first input information including a target string representing a target and a category string representing a category to which the target belongs, one or more first substrings included in the target string, and extracting, from the one or more first substrings included in the target string, one or more second substrings using the category string;
determining, for each of the plurality of pieces of first input information, one or more second substrings associated with the target string included in the first input information; and
executing learning processing to train first feature information and second feature information to increase a matching rate between a category of the target string estimated from the second feature information and a category represented by the category string, the first feature information representing a feature of the determined one or more second substrings, the second feature information representing a feature of the target string including the determined one or more second substrings, the second feature information being calculated based on the first feature information.
